(19) United States
(12) Patent Application Publication
(10) Pub. No.: US 2023/0331594 A1
(43) Pub. Date: Oct. 19, 2023

(54) Organic Compound Destruction Apparatus

(71) Applicant: Board of Trustees of Michigan State University, East Lansing, MI (US)

(72) Inventor: Qi Hua Fan, Okemos, MI (US)

(73) Assignee: Board of Trustees of Michigan State University, East Lansing, MI (US)

(21) Appl. No.: 18/135,281

(22) Filed: Apr. 17, 2023

Related U.S. Application Data
(60) Provisional application No. 63/331,937, filed on Apr. 18, 2022.

(51) Int. Cl. C02F 1/46

(52) U.S. Cl. CPC C02F 1/4608; C02F 2101/36

(57) ABSTRACT

An organic compound destruction apparatus and method are provided. In another aspect, a laterally oriented discharge arc generated from an electrode in a reactor, destroys an undesired or contaminant organic molecule in a liquid solution. Another aspect includes a system which uses electrodes and a magnetic field to generate and drive laterally oriented discharge arcs in a reactor to destroy organic compounds, such as PFAS molecules, in a liquid. Another aspect includes using at least one pair of co-axial electrodes submerged in a liquid to concentrate organic contaminants around the center electrode where gas bubbles are generated to capture and transport the contaminants to the plasma region above the liquid surface. Still another aspect includes a system which uses a grid or mesh electrode to create a discharge arc in a plasma chamber to destroy organic compounds, such as PFAS molecules, in a liquid.

### CROSS-REFERENCE TO RELATED APPLICATION

This application claims priority to U.S. provisional patent application Ser. No. 63/331,937, filed on Apr. 18, 2022, which is incorporated by reference herein.

### GOVERNMENT RIGHTS

This invention was made with government support under 1724941 and under 1917577 awarded by the National Science Foundation. The government has certain rights in the invention.

### BACKGROUND AND SUMMARY

An organic compound destruction apparatus and method are provided, and more particularly, discharge arcs generated between a pair of electrodes in a plasma reactor destroy undesired or contaminant organic molecules in a liquid.

Per-and-polyfluoroalkyl substances (“PFAS”) are a group of man-made chemicals that are persistent in the environment and human body, which can lead to adverse human health effects. PFAS molecules have been commonly used as stain repellants and fire-fighting foams which were emitted into the air and water by industrial processes used to manufacture fluoro chemicals. PFAS molecules have also entered the ground and surface water through disposal of waste and sewage sludge, and as a result of fire-fighting use. Most existing PFAS removal approaches, however, do not destroy PFAS but instead merely generate solid waste and wastewater with high concentrations of PFAS.

U.S. Patent Publication No. 2018/0222781 is entitled “Water Purification using Porous Carbon Electrode” which published to Liu et al. on Aug. 9, 2018. This device uses an electrolysis chemical reaction process in an electrolyte solution to break contaminants into small and stable molecules by using an electric current flowing between parallel electrodes. Furthermore, U.S. Patent Publication No. 2021/0379602 entitled “Electrode Apparatus for Creating a Non-Uniform Electric Field to Remove Polarized Molecules in a Fluid,” invented by common inventor Fan, discloses removing PFAS from water with electrodes. These patent publications are incorporated by reference herein.

Raj Kamal Singh, et al., “Breakdown Products from Perfluorinated Alkyl Substances (PFAS) Degradation in a Plasma-Based Water Treatment Process,” Environmental Science & Technology (2019), 53, 2731-2738, teaches a plasma reactor for the destruction of PFAS, but merely uses a discharge energy spark or arc that is generated between a longitudinal high voltage electrode and the liquid solution in a vessel. A similar arrangement is disclosed in U.S. Patent Publication No. 2016/0228844 entitled “Enhanced Contact Electrical Discharge Plasma Reactor for Liquid and Gas Processing,” published to Mededovic, et al, on Aug. 11, 2016, which is incorporated by reference herein. These conventional centerline arc approaches, however, do not efficiently and quickly destroy all types of PFAS in the liquid, especially short-chain PFAS. In addition, the arcs flow from the electrode to the liquid, which becomes part of the circuit. This leads to intensive heating to the solution, which is undesirable.

In accordance with the present invention, an organic compound destruction apparatus and method are provided. In another aspect, a laterally oriented discharge arc generated between electrodes in a plasma reactor destroys an undesired or contaminant organic molecule in a liquid solution. A further aspect of the electrodes includes a center electrode and a closed-loop outer electrode. Another aspect includes a system which uses electrodes and at least one magnet, which is preferably a closed-loop magnet, to drive the laterally oriented arc across a horizontal plane in a plasma reactor to destroy organic compounds, such as PFAS molecules, in a liquid. Still another aspect includes a system which uses a grid or mesh electrode to create a discharge arc in a plasma reactor to destroy organic compounds, such as PFAS molecules, in a liquid. A further aspect causes bubbles that carry PFAS molecules to rise and interact with a generally horizontally extending electrical discharge between an electrode and a horizontally offset outer electrode/magnet assembly.

In another aspect, an apparatus and method use a non-uniform electric field to concentrate PFAS around an active electrode in a liquid, in combination with gas bubbles generated around this active electrode to enhance the capture and transport of PFAS to the liquid surface. Still another aspect of the present apparatus and method employ a center electrode and a closed-loop magnet assembly-based outer electrode above the liquid surface to generate plasma arcs in between the electrodes, allowing effective plasma interaction with the gas bubbles that carry PFAS and rise within a liquid. A laterally elongated and substantially solid, central electrode is provided in another configuration of the present apparatus and method, in combination with a closed-loop surrounding electrode and a magnet assembly, to laterally orient an electrical arc therebetween in a plasma reactor.

The present apparatus and method are advantageous over traditional approaches. For example, the present system efficiently destroys a majority of PFAS molecules in less than sixty minutes and consumes low electrical power with negligible or substantially no heating to the liquid solution, thereby being cost effective to operate in a large-scale commercial system. Moreover, the present use of plasma effectively breaks the strong C—F bonds within PFAS molecules, thereby generating superior performance as compared to conventional remediation such as electrochemical oxidation, which consumes significantly more electric energy and requires much longer process time (e.g., many hours). Additional advantages and features of the present apparatus and method will be observed in the following description and appended claims, taken in conjunction with the accompanying drawings.

### BRIEF DESCRIPTION OF THE DRAWINGS

FIG. 1 is a diagrammatic and perspective view showing the present apparatus based on a magnetic-field-enhanced arc plasma discharge;

FIG. 2 is an exploded diagrammatic and perspective view of portions of the present apparatus;

FIG. 3 is a diagrammatic view showing a magnetic field drives the electrical discharge arcs rotating around the center electrode in the present apparatus;

FIG. 4 is a diagrammatic and perspective view showing the electrical discharge arc in a horizontal plane of the present apparatus;

FIG. 5 is an exaggerated diagrammatic view showing a PFOA molecule transported with gas bubbles to a liquid surface, employed with the present apparatus;

FIG. 6 is a diagrammatic view showing a breakdown of PFOA molecules with the present apparatus;

FIG. 7 is a diagrammatic top elevation view of the magnet assembly showing a first embodiment of the present apparatus;

FIG. 8 is a cross-sectional view, taken along line 8-8 of FIG. 7, showing the first embodiment of the present apparatus;

FIG. 9 is diagrammatic top elevation view of multiple pairs of bottom electrodes in the liquid, showing a second embodiment of the present apparatus;

FIG. 10 is a cross-sectional view, taken along line 10-10 of FIG. 9, showing the second embodiment of the present apparatus;

FIG. 11 is a diagrammatic cross-sectional view of a pair of bottom electrodes showing the second embodiment of the present apparatus;

FIG. 12 is diagrammatic top elevation view showing a third embodiment of the present apparatus;

FIG. 13 is a cross-sectional view, taken along line 13-13 of FIG. 12, showing the third embodiment of the present apparatus;

FIG. 14 is a diagrammatic top elevation view showing multiple pairs of the bottom electrodes of a fourth embodiment of the present apparatus;

FIG. 15 is a diagrammatic side elevation view showing a fifth embodiment of the present apparatus;

FIG. 16 is a top elevation view showing the fifth embodiment of the present apparatus;

FIG. 17 is a top elevation view showing a combination of multiple units of the fifth embodiment configuration of the present apparatus; and

FIG. 18 is a diagrammatic side and top elevation view showing a sixth embodiment of the present apparatus.

### DETAILED DESCRIPTION

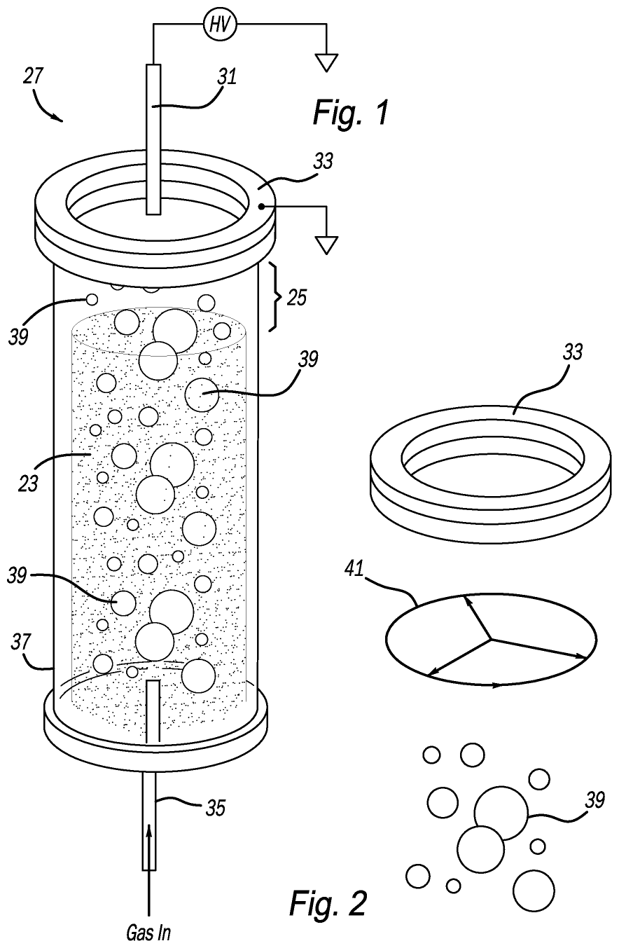

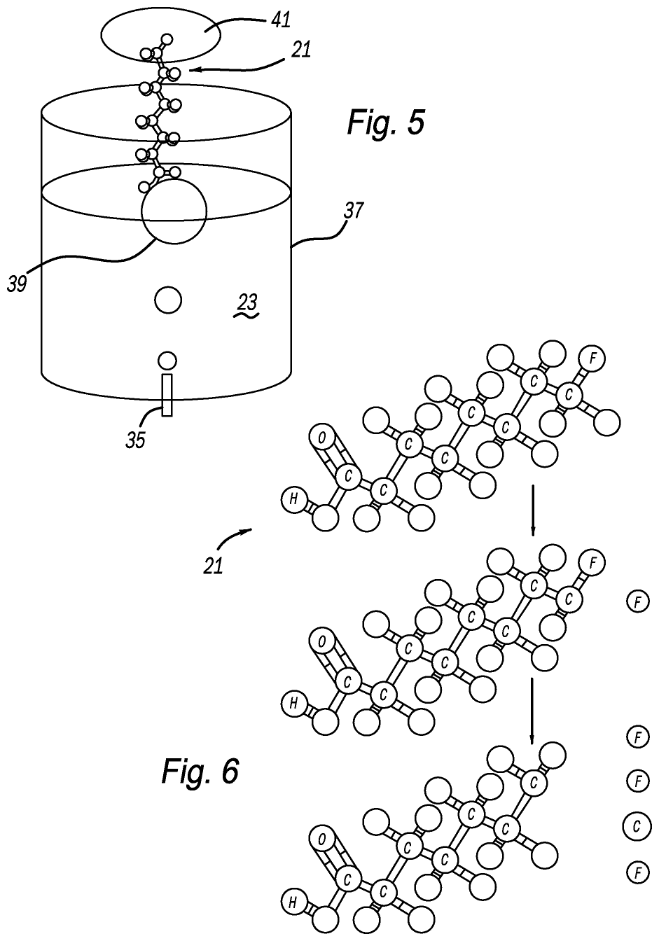

An organic compound destruction apparatus and method include a primarily laterally and horizontally oriented discharge arc, which is generated between a center electrode and a closed-loop outer electrode in a plasma reactor, to destroy undesired organic compounds in a liquid. This can be generally observed in FIGS. 1-6. Undesired organic compound contaminants include PFAS molecules 21, which have strongly bonded carbon and fluorine atoms with a functional head, in water 23. Plasma arc 41 is generated by a high-voltage power HV of amplitude about 5-15 kV in the present apparatus 27. A magnetic field in combination with the electrodes confines the plasma arc in an area above an air region 25 above the water. The plasma arc acts to effectively break the carbon-fluorine bonds (see FIG. 6) in less than about sixty minutes to the point where the undesired PFAS molecules are essentially destroyed and converted into carbon, carbon dioxide, fluoride, and harmless chemicals.

Apparatus 27 includes an upper and central electrode 31, coaxially surrounded by at least one ring magnet 33 or multiple adjacent magnets, a gas injector 35, and a holding tank 37. In this embodiment, upper central electrode 31 is a solid, metallic rod being elongated in a longitudinal direction spaced above a liquid solution in tank 37. The liquid solution includes PFAS in water 23. In contrast, gas injector 35 is a hollow tube which upwardly projects from and is located near the bottom of the solution through an aperture in a bottom of tank 37. Upper central electrode 31 and gas injector 35 are coaxially aligned in this configuration. A proximal end of gas injector 35 is connected to a gas supply and acts to flow gas, such as argon, therethrough and into the solution which creates upwardly rising bubbles 39 therein. Alternate gases include a mixture of argon plus oxygen, nitrogen, air, and the like.

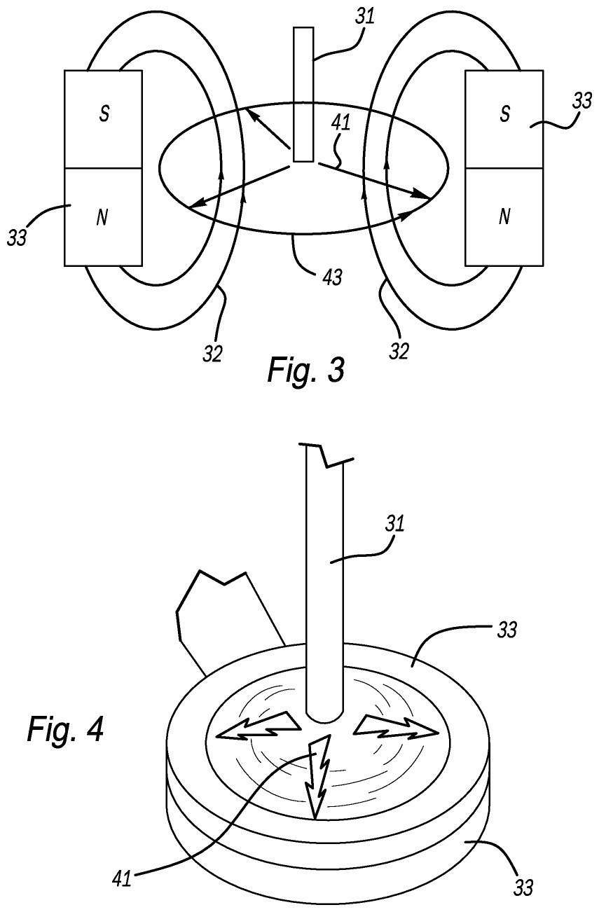

As can best be observed in FIGS. 3 and 4, electrical arc 41 is generated by central electrode 31 and is outwardly oriented primarily in a lateral direction along a generally horizontal plane. The horizontal plane is substantially perpendicular to the longitudinal axis of central electrodes 31. Magnet assembly 33 forms a closed loop and creates a magnetic field 32. The magnetic flux of magnetic field 32 consists of a primarily vertically oriented component in a horizontal plane that is perpendicular to center electrode 31 and in close approximation to the end of electrode 31. Under magnetic field 32, arc 41 may also concurrently exhibit a rotating or swirling direction 43 as it spans between upper central electrode 31 and magnets 33. The arc rotation direction depends on the orientation of the magnet.

The laterally oriented arc 41 covers at least a majority, if not an entire, upper surface area of tank 37. PFAS molecules attach to and rise with the gas bubbles 39 from the liquid solution into an upper air (preferably not vacuum) area 25 located between water 23 and a distal end of upper central electrode 31. Therefore, arc 41 will contact the PFAS-gas bubbles and destroy at least a majority, and more preferably all, of PFAS molecules 21 as they are transported to the leachate surface. The plasma arc destruction of PFAS is synergistically beneficial since the rotating arc covers almost the entire upper surface of tank 37. Furthermore, the plasma arc is between center electrode 31 and a side electrode in horizontal plane, there is no electric current going through the liquid to cause heating and evaporation of the liquid. This feature enables effective capture of PFAS by the gas bubbles and safe processing.

An optional surfactant can be added into the liquid solution to more effectively transport certain types of PFAS molecules to the liquid surface. It is alternately envisioned that contaminant organic molecules other than PFAS may be destroyed by use of the present apparatus and method, such as 1,4-dioxane, benzene, and the like.

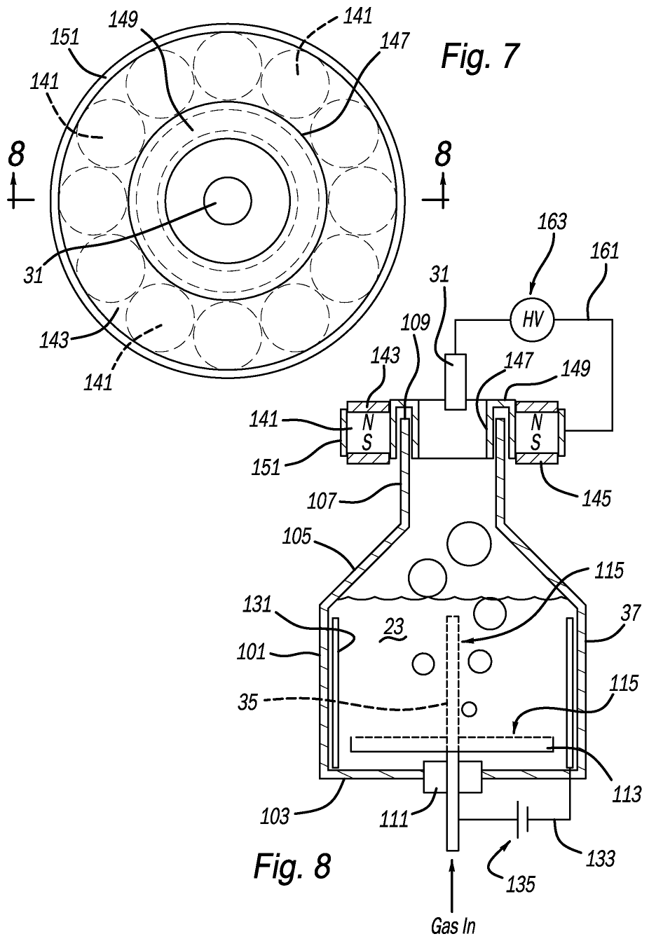

Reference should now be made to FIGS. 7 and 8. Metallic or polymeric tank 37 has a wide and cylindrical bottom section 101, adjacent a generally flat bottom 103, and an inwardly tapered shoulder section 105 leading to a cylindrical neck 107, and terminating at an upper edge 109. Water solution 23 containing PFAS and other contaminants flows into tank 37 via an inlet pipe and valve, and is held within bottom section 101 during the PFAS destruction, after which, the cleaned solution is allowed to flow out of the tank through an outlet pipe with an associated control valve.

In this configuration, a synergistically combined hollow, metallic lower center electrode and gas injector 35 are mounted to bottom 103 via a sealed insulator 111. An optional gas manifold 113 made of electrically insulative material is coupled to a middle portion of lower center electrode/gas injector 35, inside tank 37, such that the gas longitudinally flows through lower center electrode/gas injector 35, along a lateral length of manifold 113, and is then emitted into the solution via outlet holes 115 spaced along both the manifold and the lower center electrode/gas injector. The lower center electrode/gas injector and manifold form a generally+shape. Gas bubbles 39 are formed from the exiting gas, which thereby upwardly carry the PFAS molecules.

In a preferred option, the apparatus includes at least one pair of co-axial electrodes consist of lower center electrode/gas injector 35 and lower peripheral electrode 131 inside the liquid. Lower peripheral electrode 131 is inwardly spaced from tank 37. An exemplary diameter of the lower center electrode/gas injector is 1-10 mm, while an exemplary diameter of lower peripheral electrode is 10-100 mm. In one version, lower peripheral electrode 131 is a curved and solid tube, while in a second version, the lower peripheral electrode is a tubular-shape metallic grid with openings between the elongated and crossing mesh strands to allow liquid flow therethrough. An electrical circuit 133, including a low-voltage direct current power source 135, is connected to both lower center electrode/gas injector 35 and lower peripheral electrode 131.

Lower center electrode/gas injector 35 and peripheral electrode 131, advantageously create a non-uniform electric field between them. This electric field can effectively drive the PFAS toward the lower center electrode/gas injector. Meanwhile, the gas flows simultaneously from the side wall holes of the lower center electrode/gas injector to generate the bubbles. Since the PFAS molecules are concentrated around the center electrode due to this non-uniform electric field, there is an improved ability of the adjacent gas bubbles to catch the PFAS molecules and transport them to the surface of the liquid solution, where the plasma is generated and interacts with the bubbles. Thus, the non-uniform electric field due to the laterally offset co-axially structured lower electrodes, in combination with the bubbling action and plasma, creates a synergistic and multifunctional system for transporting the contaminants for subsequent destruction.

In this embodiment, multiple cylindrical or bar magnets 141 are arranged adjacent to each other to collectively define a circular assembly, co-axially surrounding neck 107 of tank 37. The permanent magnets in this embodiment have a North-South axis being substantially vertical and parallel to the longitudinal centerline of electrodes 31 and 35. The magnets may be separate parts as shown in FIG. 7 or combined as a single part as shown in FIG. 1. Metallic, conductive shunts 143 and 145 sandwich the upper and lower ends of magnets 141 therebetween if several magnet pieces are used. The shunts are preferably steel and are generally flat and annularly shaped.

A metallic carrier 147, preferably stainless steel, has an inner clamping segment 149 and an outer retention segment 151. Inner segment 149 has an inverted U-cross-sectional shape which is secured over distal end 109 of the tank and clamped onto its neck 107. Retention segment 151 holds magnets 141 and shunts 143 and 145. Carrier 147, concentrically surrounding upper central electrode 31, acts as an electrode, to generate the plasma arc with the upper central electrode.

Upper central electrode 31 is mounted through an electrically insulative lid (not shown). The lid spans across the otherwise open distal end 109 of the tank. An electrical circuit 161, including a high-voltage power source 163, is connected to upper central electrode 31 and an outer wall of magnet carrier 147. Power source 163 supplies a greater voltage than does power source 135, with power source 163 preferably being at least 10 kV amplitude and power source 135 preferably being 0.5-50 V. All of the electrodes are metallic, such as graphite, copper, stainless steel, nickel or an alloy thereof, by way of non-limiting examples.

Electrical arc 41 (see FIGS. 3 and 4) is created due to the electrical power supplied by power source 163 flowing to upper center electrode 31 and carrier 147 and being directed in the primarily lateral and horizontal direction. Driven by the magnetic field generated by magnets 141, the arc subsequently rotates in the horizontal plane. The arc, in turn, destroys the PFAS molecules riding on the gas bubbles as they upwardly move into the plasma region at the shoulder and neck sections of the tank.

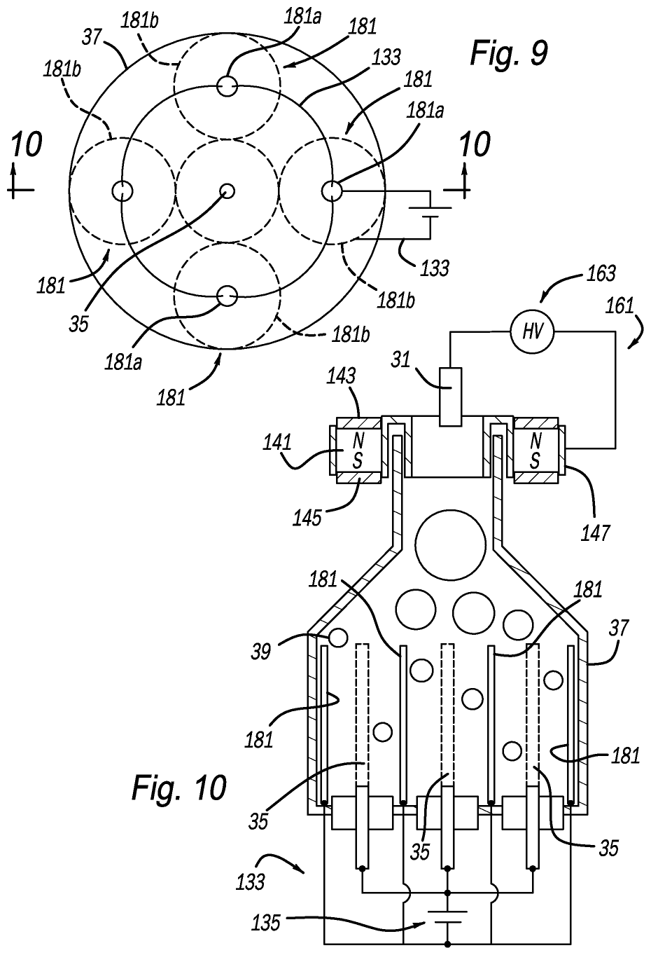

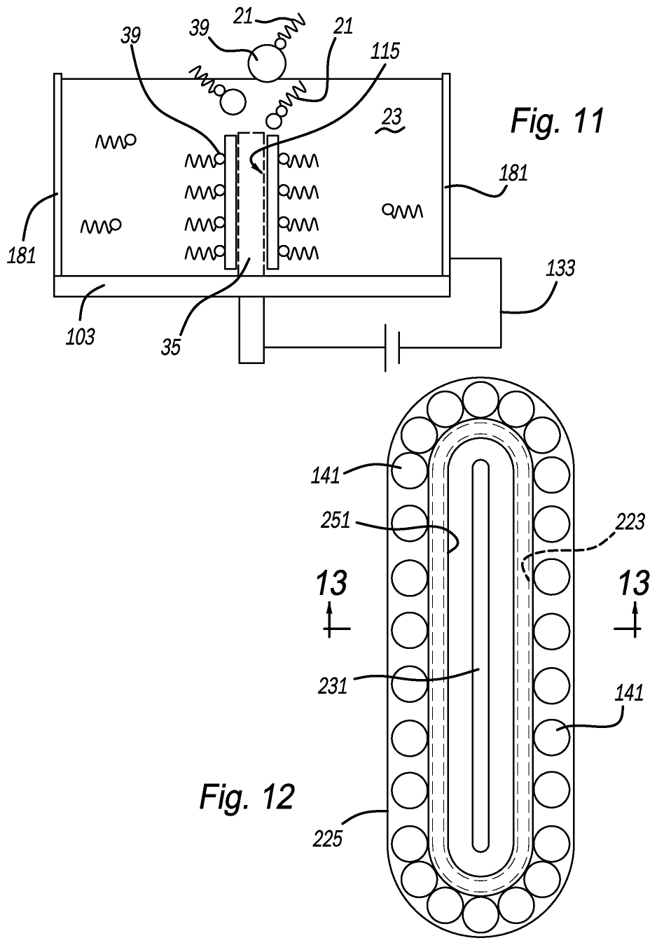

The embodiment of FIGS. 9-11 employs a tank 37, electrodes 31 and 35, magnets 141, shunts 143 and 145, and electrode carrier 147, like that of the previous configuration. However, the process gas is solely emitted by outlet holes 115 in the multiple and hollow lower electrodes/gas injectors 35, which are generally parallel and laterally spaced apart from each other. Furthermore, multiple, circumferentially spaced apart co-axial inner and outer active electrodes 181 are laterally spaced from each other and laterally alternate with lower electrodes/gas injectors 35. All of these spaced apart peripheral electrode assemblies 181 are electrically connected to low power electrical circuit 133. All of the electrodes 35 and 181 are entirely submerged in the liquid solution 23, and the liquid can flow between peripheral electrodes 181 and 35. High voltage power source 163 is connected to upper electrodes 31 and 147 via upper electrical circuit 161, while low voltage power source 135 is connected to lower electrodes 35 and 181 via lower electrical circuit 133. The upper arc direction and functionality are the same as described hereinabove.

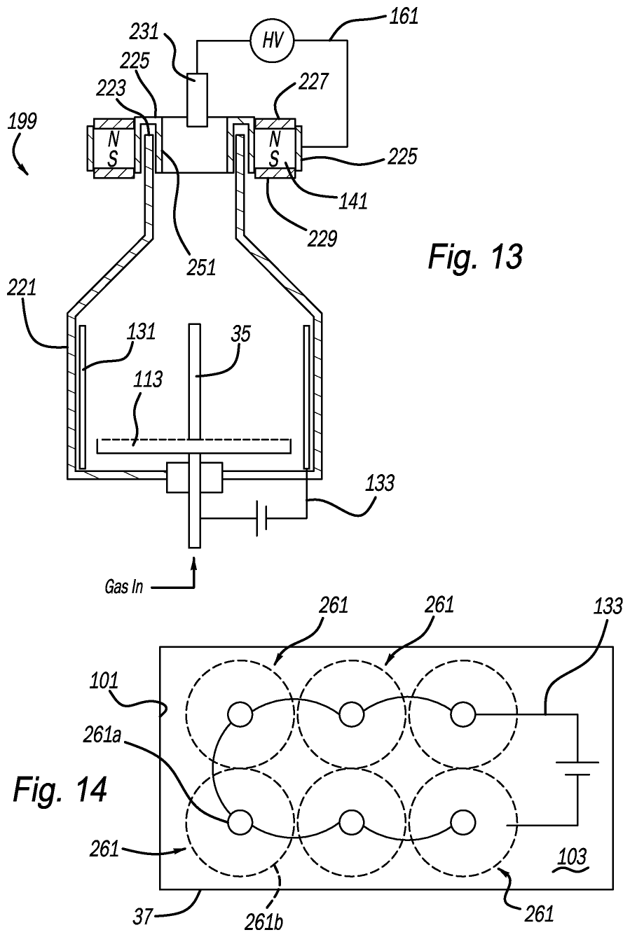

Referring now to FIGS. 12 and 13, a different embodiment of the PFAS treatment and destruction reactor apparatus 199 employs a laterally elongated tank 221 having a laterally elongated opening end 223. Electrode and gas injector 35 and electrode 231, magnets 141, electrical circuits 133 and 161, and optional gas manifold 113, are like that of the FIG. 8 configuration. However, electrode carrier 225, and shunts 227 and 229, are laterally elongated in one direction to match the tank open end, with a racetrack-shape magnet assembly held in the carrier. It is noteworthy that this construction has a solid, upper central electrode 231 that is elongated in a lateral direction coinciding with the tank direction of elongation. Electrode 231 is connected to high voltage electrical circuit 161 which is also connected to magnet carrier 225.

In this exemplary embodiment, gas injector 35 also acts as a lower center electrode and may be one or multiple spaced apart hollow, upwardly elongated active electrodes, aligned along a vertical plane defined by the longitudinal orientation of upper central electrode 231. Lower center electrode/gas injector 35 may include concentrically spaced apart pairs of electrodes like peripheral electrodes 181a and 181b illustrated in FIG. 9. Furthermore, lower peripheral electrode 131 may alternately be a solid or mesh centrically spaced apart pairs of electrodes like with any of the previously discussed versions. Again, all of the lower electrodes are preferably entirely submerged in the liquid solution while the upper central electrode has its distal end in the gaseous plasma region inside the tank. The generally horizontally and laterally oriented plasma arc is similarly created between the elongated upper central electrode 231 and a surrounding facing surface 251 of carrier electrode 225. Surface 251 has a pair of straight spaced apart and facing portions joined by arcuate lateral end portions. It is envisioned that the present embodiment can more quickly destroy a greater amount of the undesired organic molecules rising on the gas bubbles, for a high-volume system.

Still another embodiment of the PFAS treatment and destruction reactor apparatus is illustrated in FIG. 14. This configuration employs a laterally enlarged solution-filled bottom section 101 of tank 37, of a generally rectangular top view shape. The upper central electrode, magnets and associated components are essentially the same as any of the preceding or following embodiment, depending on the neck and end shapes of the tank. The lower center and/or peripheral electrodes, however, have concentric pairs active electrodes 261 which each include a hollow internal electrode 261a peripherally surrounded by an external metal screen or mesh electrode 261b. Lower electrodes 261a and 261b upwardly project from an insulated bottom 103 of tank 37, and are laterally arranged into multiple rows and columns. All of the lower electrodes are connected to the low power circuit 133. Internal electrodes 261a are preferably stainless steel and carbon, while the external electrodes have fluid passage openings between the elongated and crossing conductive strands thereof. Gas is emitted from lower internal electrodes 261a.

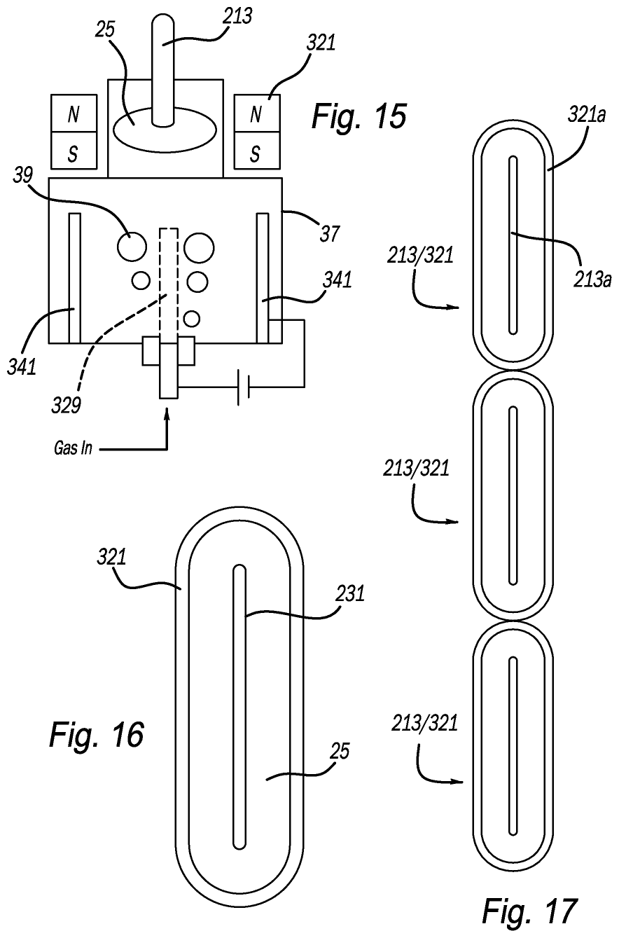

Referring now to FIGS. 15-17, the present apparatus includes a laterally elongated upper central electrode 213, shunts, a magnet carrier electrode and a plasma region 25, which function like that of the FIGS. 12 and 13 embodiments. Furthermore, magnet assembly 321 is held within the carrier electrode like that of the FIG. 13. However, there are a series of at least two laterally aligned and laterally elongated electrodes 213a and magnet assembly 321a defining a functional assembled pair. Each magnet assembly is laterally elongated with a straight middle portion and curved end portions like that of the FIG. 12. This apparatus includes multiple pairs of co-axial lower electrodes arranged in at least one row, each consisting of a lower center electrode/gas injector 329 and a peripheral electrodes 341, like that of FIG. 14. These co-axial electrodes are entirely emersed in the liquid solution within the bottom section of a laterally elongated plasma reactor tank 37.

Lower center electrode 329 preferably is a hollow tube with gas emitting holes to create gas bubbles 39 in the solution. Peripheral electrode 341 is preferably metal mesh. The co-axial electrodes 329 and 341 are laterally placed in the same direction as is upper central electrode 213.

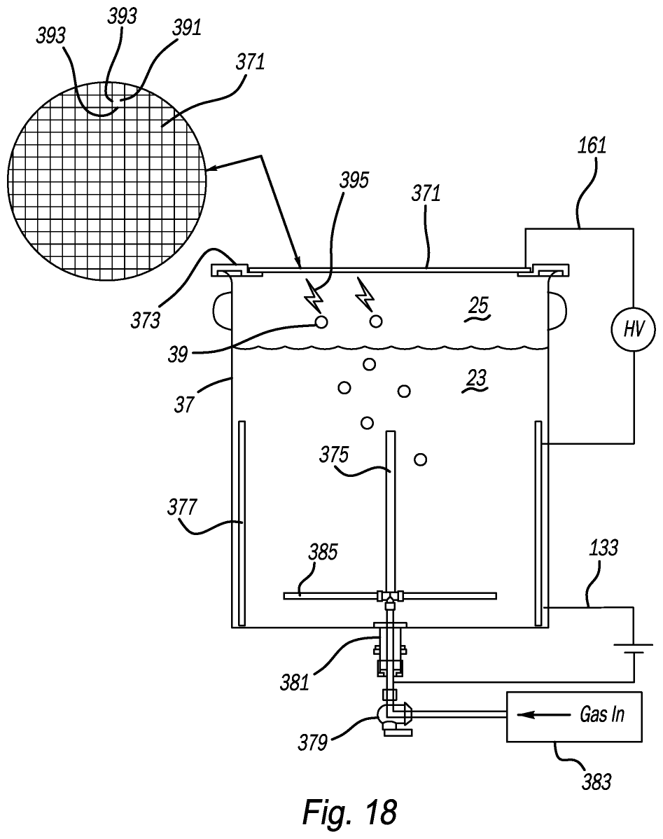

FIG. 18 shows another apparatus configuration of the present system employing an upper grid electrode 371 to create a discharge arc in a plasma region 25 to destroy organic compounds, such as PFAS molecules, in a liquid solution 23. Grid 371 is electrically connected to high power electrical circuit 161 and is coupled to the upper edge of tank 37 via a full or partial lid 373. If tank 37 is metal then lid 373 is made from an insulating material. The lower center electrode/gas injector 375 and peripheral electrode 377, may be of any of the configurations disclosed herein, and are entirely submerged in liquid solution 23. A gas inlet valve 379 and conduit/fitting 381 are coupled to a gas supply 383 to flow the plasma reactive gas through an optional manifold 385 and lower center electrode/gas injector 375. A low voltage electrical circuit 133 is connected to the lower electrodes.

Grid 371 includes openings 391 between crossing metallic strands 393 of the mesh material. Each mesh opening size is 0.5-10 mm, by way of non-limiting example. Electrical arcs 395 may be discharged from any of the grid strands, and each arc is oriented in a primarily vertical direction between the associated mesh strand and an adjacent PFAS-carrying bubble 39 moving from the liquid surface to the plasma region 25. The arc can be generated from any point on the grid strands depending on where the gas bubble rises, thereby beneficially providing full surface area coverage and rapid arc-to-PFAS interaction timing. In the preferred version of this grid embodiment, no magnets are needed.

While various embodiments have been disclosed, it should be appreciated that additional variations of the electrode apparatus and method are also envisioned. For example, additional or different gas manifold and electrode shapes and sizes may be used although certain of the present advantages may not be fully realized. Electrodes made of porous metals or other electrically conductive materials can be also used. While certain tank shapes have been disclosed it should be appreciated that alternate shapes may be used (for example, rectangular, octagonal, oval or other cross-sectional shapes) although all of the present advantages may not be fully achieved. Different electrical circuits and solution chemistry can also be provided. It is also noteworthy that any of the preceding features may be interchanged and intermixed with any of the others. Accordingly, any and/or all of the dependent claims may depend from all of their preceding claims and may be combined together in any combination. Variations are not to be regarded as a departure from the present disclosure, and all such modifications are entitled to be included within the scope and sprit of the present invention.

The invention claimed is:

1. A method for changing a property of a contaminant chemical within a liquid solution, the method comprising:
(a) supplying electricity to an upper electrode;
(b) generating an electrical arc from the upper electrode;
(c) creating a magnetic field;
(d) orienting the arc in a primarily lateral direction to the upper electrode and perpendicular to the magnetic field;
(e) driving the arc to rotate around a centerline axis of the upper electrode by the magnetic field;
(f) causing bubbles to rise in the liquid solution along a primarily longitudinal direction, at least one of the bubbles carrying the contaminant chemical thereon; and
(g) the laterally oriented arc interacting with the contaminant chemical to change the property of the contaminant chemical.

2. The method of claim 1, wherein:
the electrical arc is generated by a high-voltage of about 5-15 kV;
the magnetic field is created by a single ring magnet or a closed loop magnet assembly which concentrically surrounds and is laterally spaced away from at least a portion of the upper electrode; and
confining the arc, which is a plasma arc, in a region above the liquid solution.

3. The method of claim 1, wherein the change of property comprises breaking carbon-fluorine bonds in the containment chemicals, which are PFAS compounds, and converting the PFAS compounds into at least carbon, carbon dioxide and fluoride.

4. The method of claim 1, wherein:
the upper electrode is located along and elongated in the longitudinal direction on the centerline axis;
the magnetic field is created by a ring magnet which is laterally spaced away from at least a portion of the upper electrode;
a hollow gas injector is located adjacent a bottom of a tank which holds the liquid solution, the gas injector emitting the gas bubbles;
the magnetic field causing the arc to rotate and extend along a substantially horizontal plane spanning between the upper electrode and the ring magnet; and
the arc covering at least a majority of a surface of the tank at the substantially horizontal plane in order to contact the gas bubbles and destroy a majority of the containment chemicals rising through the liquid solution with the gas bubbles.

5. The method of claim 1, further comprising using the arc to destroy a majority of the containment chemicals, which are PFAS compounds, rising through the liquid solution with the gas bubbles, but with no electric current causing heating and evaporation of the liquid solution.

6. The method of claim 1, further comprising using the arc to destroy a majority of the containment chemicals, which are 1,4-dioxane or benzene and the like molecules, rising through the liquid solution with the gas bubbles, but with no electric current causing heating and evaporation of the liquid solution.

7. The method of claim 1, further comprising:
flowing a water solution including the containment chemical, which comprises PFAS molecules, into a tank via an inlet pipe and valve;
destroying at least a majority of the PFAS molecules in the tank with the arc; and
flowing a cleaned solution out of the tank through an outlet pipe and valve.

8. The method of claim 1, further comprising:
emitting the gas bubbles from multiple spaced apart holes in at least one gas manifold upwardly projecting into the liquid solution from a bottom of a tank holding the liquid solution, opposite from the upper electrode;
at least one lower electrode located in the liquid solution internal to the tank, and being elongated substantially parallel to the manifold and to the centerline axis; and
upwardly carrying the containment chemicals toward the arc with the gas bubbles.

9. The method of claim 1, further comprising:
a first lower electrode located in the liquid solution internal to the tank;
at least a second lower electrode located in the liquid solution internal to and adjacent a side wall of the tank, the lower electrodes being laterally spaced apart from each other;
creating a non-uniform electric field around the lower electrodes; and
upwardly carrying the containment molecules toward the arc with the gas bubbles.

10. The method of claim 1, further comprising:
concentric pairs of spaced apart lower electrodes located in the liquid solution internal to the tank;
each of the concentric pairs comprising a hollow internal lower electrode and a peripherally surrounding external screen or mesh lower electrode; and
emitting the gas bubbles from the internal lower electrode of each of the concentric pairs.

11. The method of claim 1, further comprising:
generating a plasma in a region within a tank, above the liquid solution;
supplying a voltage of 5-15 kV to the upper electrode to create the arc in the plasma in a neck of the tank of a reduced lateral dimension as compared to a larger lateral dimension of a portion of the tank holding the liquid solution, the upper electrode extending into the tank through an electrically insulative lid; and
using the magnetic field to rotate the arc along a substantially horizontal plane.

12. A method for changing a property of PFAS compounds within a liquid solution, the method comprising:
(a) supplying electricity to an upper electrode;
(b) generating an electrical arc from the upper electrode;
(c) positioning the arc in a region above the liquid solution in a tank;
(d) creating a non-uniform electric field around lower electrodes located in the liquid solution, internal to the tank;
(e) generating gas bubbles within the liquid solution, the gas bubbles rising in the liquid solution and upwardly carrying the PFAS molecules to the region; and
(f) the arc destroying a majority of the PFAS molecules rising with the bubbles, without evaporating the liquid solution.

13. The method of claim 12, further comprising:
creating a magnetic field with a magnet assembly substantially surrounding a portion of the upper electrode;
orienting the arc in a primarily lateral direction to the upper electrode and perpendicular to the magnetic field; and
rotating the arc to around a centerline axis of the upper electrode by the magnetic field.

14. The method of claim 12, wherein the upper electrode comprises a substantially laterally extending grid having a metallic mesh with openings between strands, the arc being generated from the strands.

15. The method of claim 12, where in the upper electrode is elongated along a centerline longitudinal axis of the tank, and the tank has a reduced neck at the region within which the upper electrode extends.

16. The method of claim 12, further comprising:
flowing the liquid solution including the PFAS compounds into the tank via an inlet pipe and valve;
destroying at least a majority of the PFAS compounds in the tank with the arc; and
flowing a cleaned solution out of the tank through an outlet pipe and valve.

17. The method of claim 12, further comprising:
emitting the gas bubbles from multiple spaced apart holes in at least one gas manifold upwardly projecting into the liquid solution from a bottom of the tank, opposite from the upper electrode; and
at least one lower electrode located in the liquid solution internal to the tank, and being elongated substantially parallel to the manifold.

18. The method of claim 12, further comprising:
spaced apart and concentric pairs of the lower electrodes located in the liquid solution internal to the tank;
each of the concentric pairs comprising a hollow internal lower electrode and a peripherally surrounding external screen or mesh lower electrode; and
emitting the gas bubbles from the internal lower electrode of each of the concentric pairs.

19. A plasma apparatus comprising:
(a) a solution including liquid and undesired organic compounds;
(b) a tank holding the solution;
(c) an upper electrode located above the liquid surface and powered by a high-voltage power supply to generate a plasma arc;
(d) a magnet assembly configured to create a magnetic field substantially perpendicular to a direction of the plasma arc;
(e) lower electrodes comprising a gas injector, configured as an active electrode, and a peripheral electrode spaced away from the active electrode, the lower electrodes being entirely submersed in the solution and connected to a low-voltage DC power supply;
(f) gas emitted from the gas injector configured to generate bubbles in the solution; and
(g) the gas bubbles rising into a region of the plasma arc.

20. The apparatus of claim 19, wherein the gas injector includes multiple spaced apart holes, the gas injector upwardly projects into the liquid solution from a bottom of a tank holding the liquid solution, and the holes emit the gas bubbles.

21. The apparatus of claim 19, further comprising:
another lower electrode located in the liquid solution internal to and adjacent a side wall of the tank, the lower electrodes being laterally spaced apart from each other;
a non-uniform electric field being created around the lower electrodes; and
the gas bubbles upwardly carrying PFAS compounds toward the arc.

22. The apparatus of claim 19, further comprising:
concentric pairs of spaced apart of the lower electrodes located in the liquid solution internal to the tank;
each of the concentric pairs comprising the gas injector, which is hollow, and a peripherally surrounding external screen or mesh lower electrode; and
the gas bubbles emitted from the gas injector of each of the concentric pairs upwardly carrying harmful chemicals toward the arc which are then destroyed by the arc.

23. The apparatus of claim 19, further comprising:
a plasma located in the region within a tank, above the liquid solution;
a voltage of 5-15 kV supplied to the upper electrode to create the arc in the plasma in a neck of the tank, the neck having a reduced lateral dimension as compared to a larger lateral dimension of a portion of the tank holding the liquid solution; and
the magnetic field rotating the arc along a substantially horizontal plane.

24. A plasma apparatus comprising:
(a) a solution including liquid and undesired organic compounds;
(b) a tank holding the solution;
(c) a mesh electrode spanning laterally across the tank, the mesh including openings therein;
(d) a lower center electrode located inside the tank;
(e) a lower peripheral electrode laterally spaced away from the lower center electrode inside the tank, the lower electrodes being entirely submersed in the solution;
(f) gas emitted into the tank through a conduit and upwardly flowing through the solution; and
(g) an electrical arc flowing from the mesh electrode to the undesired organic compounds when they move from the solution to a plasma region adjacent the mesh electrode which is above the lower electrodes.

25. The apparatus of claim 24, wherein the mesh electrode comprises the openings between metallic strands, the mesh electrode being located above the liquid, and the undesired organic compounds being at least one of: PFAS, 1,4-dioxane or benzene and the like molecules.

26. The method of claim 24, further comprising:
at least one gas manifold having multiple spaced apart holes therein, the manifold upwardly projecting into the liquid solution from a bottom of the tank, opposite from the upper electrode; and
at least one lower electrode located in the liquid solution internal to the tank, and being elongated substantially parallel to the manifold.
